(19) United States
(12) Patent Application Publication
(10) Pub. No.: US 2007/0115402 A1
(43) Pub. Date: May 24, 2007

(54) LIQUID CRYSTAL DISPLAY DEVICE

(75) Inventors: YUE-HAI ZHANG, Shenzhen (CN); WEN-KANG LO, Tu-Cheng,Taipei Hsien (TW); HUNG-CHUN LU, Tu-Cheng,Taipei Hsien (TW); CHIEN-LI TSAI, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/557,108

(22) Filed: Nov. 7, 2006

(30) Foreign Application Priority Data
Nov. 18, 2005 (CN) 200520067944.7

(51) Int. Cl. G02F 1/1333

(52) U.S. Cl. 349/60

(57) ABSTRACT

A liquid crystal display (LCD) device includes a bracket, an LCD panel, and a mounting member. The bracket includes a bezel, and a cover mounted to the bezel. One of the bezel and the cover includes a first side, and a second side opposite to the first side. A side of the LCD panel is mounted to the first side of the one of the bezel and the cover. The mounting member secures to an opposite side of the LCD panel. The mounting member includes a mounting tab being capable of mounting to the positioning portion at different positions relative to the positioning portion.

### BACKGROUND OF THE INVENTION

1. Field of the Invention

The present invention relates to liquid crystal display (LCD) devices, and particularly to an adjustable LCD device able to receive LCD panels of different sizes.

2. Description of Related Art

A typically folded electronic device, such as a notebook computer, includes a main system, and an LCD unit pivotably mounted to the main system. The LCD unit includes a bracket, and an LCD panel. A plurality of screw holes is defined in opposite sides of the LCD panel. A plurality of through-holes is defined in opposite sides of the bracket. Screws are inserted through the through-holes to engage in the corresponding screw holes to secure the LCD panel to the bracket.

In Taiwan Patent No. 478603, an LCD unit of a notebook computer includes a cover, a bezel, an LCD panel, a pair of elastic members, and a plurality of screws. In assembling the LCD panel, the elastic members are mounted to opposite sides of the LCD panel via a plurality of screws. The elastic members are mounted to opposite sides of the cover via a plurality of screws, too. Then, the bezel is mounted to the cover via a plurality of screws. However, the LCD panels may vary in dimension because of imprecise manufacturing techniques, and assembly workers may try to force a fit of the LCD panel in the device thereby risking damage in the securing process. Further, if an LCD panel is not within spec for the fit it may be wasted.

What is desired, therefore, is an LCD device with a greater range of tolerance in receiving LCD panels of different sizes.

### SUMMARY OF THE INVENTION

An exemplary liquid crystal display (LCD) device includes a bracket, an LCD panel, and a mounting member. The bracket includes a bezel, and a cover mounted to the bezel. One of the bezel and the cover includes a first side, and a second side opposite to the first side. A side of the LCD panel is mounted to the first side of the one of the bezel and the cover. The mounting member secures to an opposite side of the LCD panel. The mounting member includes a mounting tab being capable of mounting to the positioning portion at different positions relative to the positioning portion.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of an LCD device in accordance with a preferred embodiment of the present invention, the LCD device includes a bezel, a cover, a mounting member, and an LCD panel;

FIG. 2 is an enlarged view of the mounting member of FIG. 1;

FIG. 3 is an assembled view of the cover, the mounting member and the LCD panel of FIG. 1; and

FIG. 4 is an assembled view of FIG. 1.

### DETAILED DESCRIPTION OF THE INVENTION

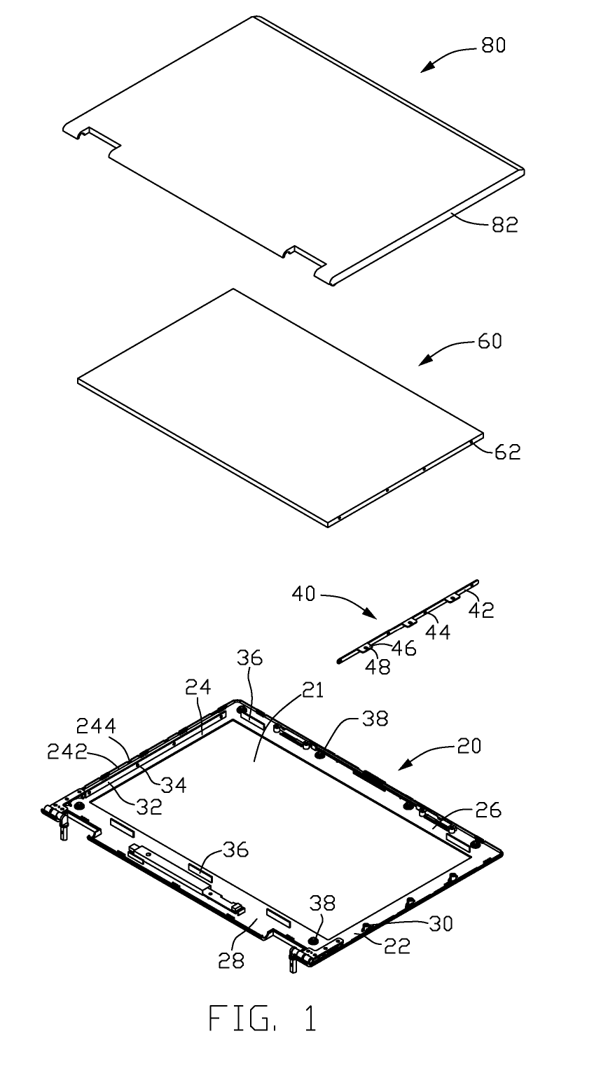

Referring to FIG. 1, a liquid crystal display (LCD) device in accordance with a preferred embodiment of the present invention includes a bracket, a mounting member 40, and an LCD panel 60 defining a plurality of locking holes 62 in two opposite sides thereof. The bracket includes a bezel 20, and a cover 80.

The bezel 20 defines an opening 21 therein. The bezel 20 includes a first side 22, a second side 24 opposite to the first side 22, a third side 26, and a fourth side 28 opposite to the third side 26, cooperatively defining the opening 21 therebetween. A plurality of positioning posts 30 each defining a screw hole protrudes up from the first side 22. A mounting plate 32 extends up from the second side 24. A plurality of through-holes 34 is defined in the mounting plate 32. A flange 242 parallel to the mounting plate 32 extends up from an edge of the second side 24. A plurality of cutouts 244 is defined in the flange 242. The cutouts 244 of the flange 242 align with the corresponding through-holes 34 of the mounting plate 32. A plurality of restriction tabs 36 extends up from the third side 26 and the fourth side 28, and a plurality of mounting holes 38 is defined in the third side 26 and the fourth side 28 near to the first and second sides 22, 24.

The cover 80 includes two flanges 82 bent down from two opposite sides thereof respectively. A plurality of covering tabs (not shown), configured for covering the cutouts 244 to prevent dust and/or debris entering thereby, extends from one of the two flanges 82. Each covering tab corresponds to a cutout 244 of the flange 242. A plurality of poles (not shown) extends down from an inner surface of the cover 80. Each pole defines a threaded hole in a distal end for receiving a screw (not shown) extending from the bezel 20.

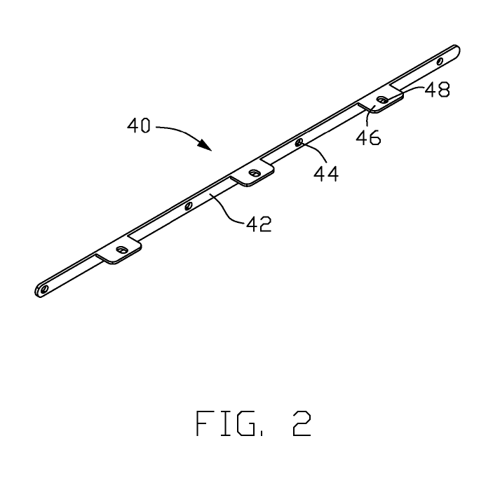

Referring also to FIG. 2, the mounting member 40 includes a thin fixing plate 42 defining a plurality of through holes 44, corresponding to the locking holes 62 of one side of the LCD panel 60. A plurality of mounting tabs 46 perpendicularly extends from an upper edge of the fixing plate 42 of the mounting member 40, corresponding to the positioning posts 30 of the bezel 20. Each mounting tab 46 defines an elongate slide hole 48 having a long axis perpendicular to the fixing plate 42 of the mounting member 40.

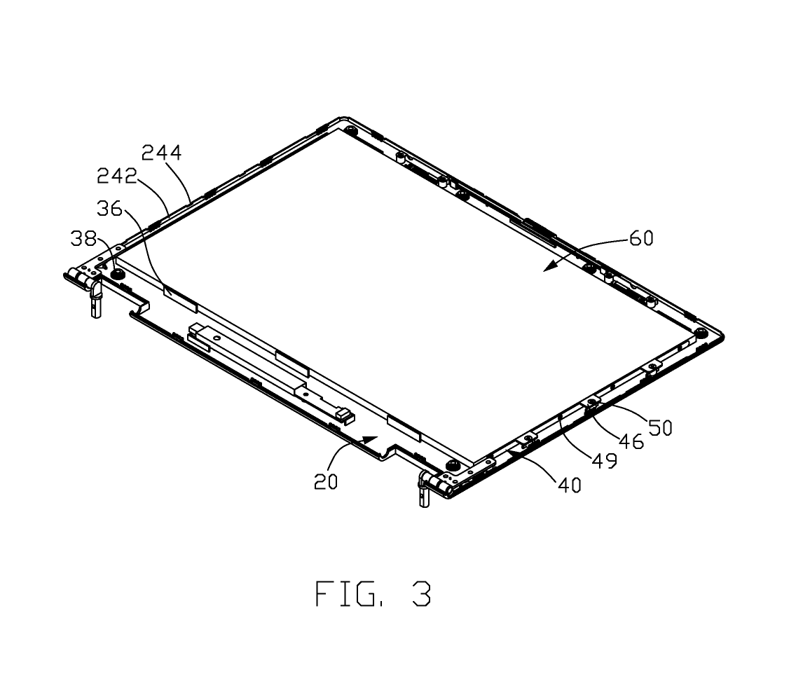

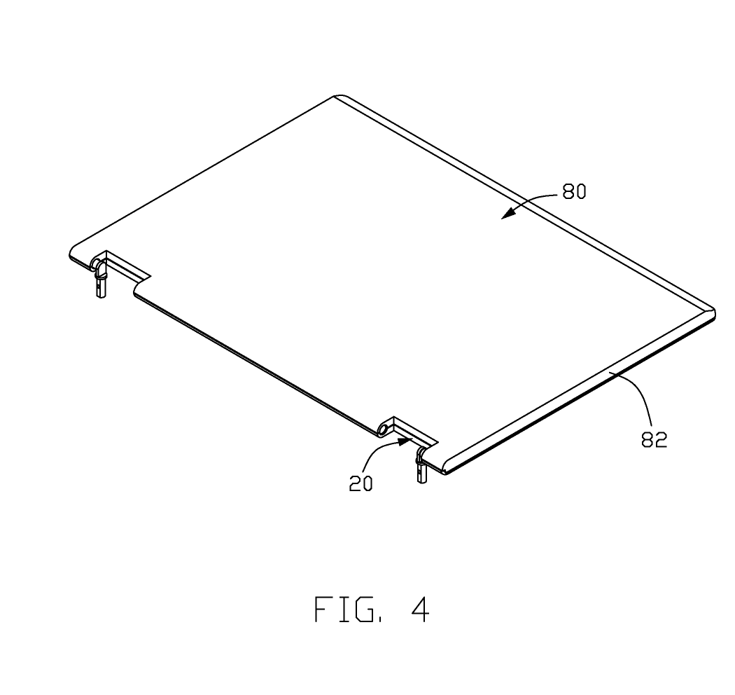

Referring also to FIGS. 3 and 4, in assembly, a plurality of screws 49 are inserted through the through holes 44 of the mounting member 40 to engage in the corresponding locking holes 62 of one side of the LCD panel 60. Thus, the mounting member 40 is mounted to the LCD panel 60. The LCD panel 60 is accommodated among the restriction tabs 36, the mounting plate 32, and the positioning posts 30, of the bezel 20. A plurality of screws (not shown) is inserted through the through-holes 34 of the mounting plate 32 to engage in the corresponding locking holes 62 of an opposite side of the LCD panel 60. The cutouts 244 of the flange 242 define accesses for extension of a tool such as a screwdriver therein. A plurality of screws 50 is inserted through the slide holes 48 of the corresponding mounting tabs 46 to engage in the screw holes of the corresponding positioning posts 30. Thus, the LCD panel 60 is mounted to the bezel 20. Most of the LCD panel 60 is exposed from the opening 21 of the bezel 20 for being viewed by a user. A plurality of screws (not shown) is inserted through the mounting holes 38 of the bezel 20 to engage in the corresponding screw holes of the cover 80, for assembling the bezel 20 to the cover 80.

In another method of assembly, the mounting member 40 may be movably mounted to the bezel 20 by screws 50 which are partly threaded into the corresponding screw holes of the positioning posts 30. The LCD panel 60 is accommodated among the restriction tabs 36, the mounting plate 32, and the mounting member 30. Two opposite sides of the LCD panel 60 are mounted to the mounting plate 32 of the bezel 20 and the mounting member 40, respectively. The screws 50 are threaded fully into the positioning posts 30 for tightly engage the mounting tabs 46 with the positioning posts 30, so that the mounting member 40 will not move any more. Thus, the LCD panel 60 is mounted to the bezel 20. The cover 80 is then mounted to the bezel 60 by screws.

Because each of the slide holes 48 is an elongate hole, a greater margin of error can be allowed for in dimensions of the LCD during manufacturing thus reducing waste.

In other embodiments of the present invention, the positioning posts 30, the mounting plate 32, and the restriction tabs 36 may be formed at the cover 80. Then, the cutouts 244 may be defined in one of the flanges 82 of the cover 80, and the covering tabs may extend from the flange 242 of the bezel 20. The cover 80 may be mounted to the bezel 20 by other ways, such as latches formed on one of the cover 80 and the bezel 20, and corresponding holes or latches formed on the other one of the cover 80 and the bezel 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display (LCD) device, comprising:
a bracket comprising a bezel, and a cover mounted to the bezel, one of the bezel and the cover comprising a first side, and a second side opposite to the first side;
an LCD panel mounted between the bezel and the cover, a side of the LCD panel mounted to the first side of the one of the bezel and the cover; and
a mounting member securing to an opposite side of the LCD panel, the mounting member comprising a mounting tab being capable of mounting to the positioning portion at different positions relative to the positioning portion.

2. The LCD device as claimed in claim 1, wherein the mounting tab mounted to the second side of the one of the bezel and the cover, and defines an elongate slide hole having a long axis perpendicular to the opposite side of the LCD panel.

3. The LCD device as claimed in claim 2, wherein a positioning post protrudes from the second side of the one of the bezel and the cover, a screw is inserted through the slide hole of the mounting member to engage in the positioning post.

4. The LCD device as claimed in claim 2, wherein the mounting member further comprises a fixing plate perpendicular to the mounting tab, for being mounted to the opposite side of the LCD panel.

5. The LCD device as claimed in claim 4, wherein a plurality of through holes is defined in the fixing plate, a plurality of locking holes is defined in the corresponding side of the LCD panel, a plurality of screws is inserted through the through holes of the fixing plate to engage in the corresponding locking holes of the LCD panel.

6. The LCD device as claimed in claim 1, wherein the one of the bezel and the cover further comprises a mounting plate mounted to the first side thereof, for fixing the a side of the LCD panel.

7. The LCD device as claimed in claim 6, wherein a plurality of through-holes is defined in the mounting plate, a plurality of locking holes is defined in the a side of the LCD panel, a plurality of screws is inserted through the through-holes of the mounting plate to engage in the corresponding locking holes of the LCD panel.

8. The LCD device as claimed in claim 7, wherein the one of the bezel and the cover further comprises a flange parallel and adjacent to the mounting plate, the flange defines a plurality of cutouts aligning with the corresponding through-holes of the mounting plate.

9. The LCD device as claimed in claim 6, wherein the one of the bezel and the cover further comprises a third side and a fourth side opposite to the third side, each of the third side and the fourth side defines a plurality of restriction tabs perpendicular to the mounting plate, for engaging with the LCD panel.

10. A mounting device for mounting an LCD panel thereto, comprising:
a bracket comprising a bezel and a cover configured for mounting the LCD panel therebetween, the bezel defining an opening for exposing the LCD panel, a locking portion formed at one side of the bracket for engaging with one side of the LCD panel, a positioning portion formed at an opposite side of the bracket; and
a mounting member configured for securing to an opposite side of the LCD panel, the mounting member comprising a mounting portion being capable of mounting to the positioning portion at different positions relative to the positioning portion.

11. The mounting device as claimed in claim 10, wherein the positioning portion defines a screw hole, the mounting portion defines an elongate hole, and a screw is insertable through the elongate hole to engage in the screw hole to thereby mount the mounting portion to the positioning portion at the different positions.

12. The mounting device as claimed in claim 11, wherein the mounting member further comprises a fixing plate configured for mounting to the LCD panel, the mounting portion extending perpendicularly from one side edge of the fixing plate.

13. The mounting device as claimed in claim 11, wherein the bezel comprises a plurality of restriction members extending perpendicularly from three sides thereof for positioning three sides of the LCD panel relative to the bracket.
